(19) United States
(12) Patent Application Publication
(10) Pub. No.: US 2008/0055788 A1
(43) Pub. Date: Mar. 6, 2008

(54) Perpendicularly feeding type magnetic head having adjustable input impedance, manufacturing method thereof, head suspension assembly, and magnetic storage device

(75) Inventor: Hirofumi Nagai, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/712,875

(22) Filed: Mar. 1, 2007

(30) Foreign Application Priority Data
Aug. 31, 2006 (JP) 2006-236821

(51) Int. Cl. G11B 5/127

(52) U.S. Cl. 360/323

(57) ABSTRACT

This invention provides a magnetic head having adjustable input/output impedance, and also provides a manufacturing method of the same, a head suspension assembly and a magnetic storage device. The magnetic head has a perpendicularly feeding type magnetoresistive element, a pair of electrodes, a pair of first conductive wires for electrically connecting the pair of electrodes to a detecting circuit device, a pair of second conductive wires for discharging static electricity by electrically connecting the pair of the first conductive wires and a grounded substrate through bleed resistance, and one or more grounded electrically shielded layers between the first conductive wires and the substrate, and/or between the second conductive wires and the substrate. Impedance between the grounded substrate and the first conductive wires, and impedance between the substrate and each bleed resistor, can be better balanced by adjusting capacitance among the grounded electrically shielded layers, by removing selected ground connections of the shielded layers.

The present invention relates to a perpendicularly feeding type magnetic head, head suspension assembly, and magnetic storage device, and more specifically to a structure for adjusting the impedance of the perpendicularly feeding type magnetic head.

### BACKGROUND OF THE INVENTION

With improvements in the capacity and size of hard disk drives (HDD), a highly sensitive and high output thin film magnetic head is needed. In order to satisfy this need, refinements continue to be made in GMR heads that have a giant magnetoresistive read head element. Meanwhile, a TMR head including a tunnel magnetoresistive read head element which is expected to provide a magnetoresistive ratio of twice or more than that of the GMR head is also being developed.

The TMR head and an ordinary GMR head are different from each other in a head structure because of differences in the flowing direction of a sense current. An ordinary GMR head where the sense current flows parallel to a laminating surface (film surface) is called a CIP (Current In Plane) structure, and a TMR head where the sense current flows perpendicular to the film surface is called a CPP (Current Perpendicular to Plane) structure. Lately GMR heads having the latter CPP structure are also being developed.

A conventional magnetic head using a tunnel magnetoresistive element is shown in FIGS. 1(a) and 1(b). Ferromagnetic layers 8 are allocated on the right and left sides of an element 1 and these layers are held between upper and lower shields 9, 10. Moreover, the upper shield 9 and lower shield 10 are connected with conductive wires 11(a), 11(b), and bonding pads 12a and 12b are provided for the conductive wires 11(a), 11(b). Like reference numerals in the drawings are used in common throughout the drawings.

A cross-sectional view along the line A-A′ of FIG. 1(a) is shown in FIG. 1(b). This figure corresponds to a cross-sectional view of a tunnel magnetoresistive element. An element 1 for detecting a magnetic field has a free magnetic layer 2, a pinned magnetic layer 3, an anti-ferromagnetic layer 4 for pinning the pinned magnetic layer 3, and a non-magnetic layer 5 provided between the free magnetic layer 2 and the pinned magnetic layer 3. Magnetization of the pinned magnetic layer 3 is pinned only in the constant direction of magnetization of the anti-ferromagnetic layer 4. The free magnetic layer 2 is capable of rotating its magnetization angle in response to a magnetic field of a medium.

The non-magnetic layer 5 is formed of an insulating material such as Al₂O₃. On both sides of the element 1, ferromagnetic layers 8 are allocated via an insulating layer 6 such as Al₂O₃ and an underlayer 7 such as Cr in order to apply a longitudinal bias field. Moreover, conductive layers 9, 10, also working as magnetic shields and electrodes, are joined to the upper and lower portions of the element 1.

A cross-sectional view along the line B-B′ of FIG. 2(a) is shown in FIG. 2(b). FIG. 2(a) is a plan view of the magnetic head shown in FIG. 1(a) viewed from the direction perpendicular to the film surface. The upper shield 9 is connected to the conductive wire 11a, while the lower shield 10 is connected to the conductive wire 11b. Accordingly, a current flows through the path formed by the conductor 11a, upper shield 9, element 1 (FIG. 1(b)), lower shield 10 and conductor 11b from a detecting circuit (not shown) provided outside the device. As a result, the magnetic head can change resistance in response to a magnetic field from a magnetic recording media.

Referring now to FIGS. 9, 10(a) and 10(b), a magnetic disk 18 is covered with an insulator such as a protection film or a lubrication film and the surface faced media of slider 24 is covered with a protection film, too. As a result, static electricity is generated by the flow of air generated by rotation of the magnetic disk 18, namely by the flow of gas molecules or by sliding friction between the surface faced media of slider 24 and the magnetic disk 18. This static electricity is charged or stored within the magnetic disk 18 and the slider 24. In operation, the slider 24 floats over or slides on the magnetic disk 18, keeping a minute gap of about 0.1 μm or less. Therefore, such charged static electricity is discharged toward the element 1 when the charged static electricity exceeds the dielectric strength of the air or dielectric strength of the protection film and lubricating film.

On the other hand, a read head element, particularly, of the TMR head and GMR head is improved through reduction in thickness and the dielectric strength thereof, for the applied voltage is very low. When the dielectric strength of the read head element is lowered, adverse effects and breakdown of the element by electrostatic discharge (ESD) becomes a significant problem.

In order to ensure higher reliability by eliminating adverse effects on the magnetoresistive read head element resulting from such ESD, Japanese Unexamined Patent Publication No. 1999-175931 discloses a thin film magnetic head for grounding the lower shield layer and upper shield layer and holding a magnetoresistive film between the shield layers. However, in the thin film magnetic heads having a read head element to which a sense current is applied in the direction perpendicular to the film surface like the TMR head and GMR head of the CPP structure, it is impossible to shield the read head element by grounding these layers, because the lower shield layer and the upper shield layer themselves form electrodes.

Therefore, Japanese Unexamined Patent Publication No. 2002-358611 discloses a bleed resistance electric terminal having a comparatively large electric resistance between the magnetic shield and substrate or between the magnetoresistive element and the substrate. In the structure explained above, adverse effects on the element and breakdown of the element by electrostatic discharge (ESD) can be prevented even in the thin film magnetic head provided with a read head element to which the sense current is applied in the direction perpendicular to the film surface.

FIG. 3(a) is a schematic circuit diagram of a conventional magnetic head using a tunnel magnetoresistive element with bleed resistance electric terminals, while FIG. 3(b) is a plan view of the magnetic head of FIG. 3(a) viewed from the direction perpendicular to the film surface. Bleed resistance electric terminals 13a, 13b are electrically connected to the upper and lower magnetic shields and electrodes 9, 10 via the lead-out conductor wires 11a, 11b and to the substrate 15 via a connection strap 14. This substrate 15 is processed into the slider 24 and is grounded via the suspension 21 (FIG. 9), actuator arm 20, and housing 23.

The bleed resistance electric terminals 13a, 13b (FIGS. 3(a) and 3(b)) are formed in the winding structure in order to increase the resistance values R+ and R− thereof and these are provided in parallel to the substrate, holding an insulator (not illustrated) between them. Here, it is difficult to keep capacitances C+ and C− between the bleed resistance electric terminals 13a, 13b and the substrate 15 at a constant value in mass production because the film thickness of the insulating layer (not illustrated) held between the bleed resistance electric terminals 13a, 13b and the substrate 15 is not uniform.

Moreover, the upper shield 9 and the lower shield 10, which are also electrodes, are sometimes different in shape. In this case, an impedance Z+, Z− between the grounded substrate and each bleed resistance electric terminal 13a, 13b through the element 1, and the upper and lower magnetic shields and electrodes 9, 10 is not balanced in the positive (Z+)/negative (Z−) sides.

Accordingly, a voltage is induced in the element 1 when disturbance noise such as electromagnetic wave interference and electron injection is applied thereto. Such voltage appears as noise on the read signal and causes a rise in the error rate of the device.

Meanwhile, due to the structure of the bleed resistance electric terminals 13a, 13b, the impedance between the grounded substrate and each bleed resistance electric terminal 13a, 13b through the element 1, and the upper and lower magnetic shields and electrodes 9, 10 can be adjusted at the positive (Z+)/negative (Z−) sides. However, if the upper and lower magnetic shields and electrodes 9, 10 are changed in structure, the bleed resistance electric terminals 13a, 13b must be redesigned, resulting in a delay in the development of new magnetic head designs.

Therefore, it is an object of the present invention to provide a magnetic head in which impedance between the grounded substrate and each bleed resistance electric terminal 13a, 13b through the element 1, and the upper and lower magnetic shields and electrodes can be adjusted during or after manufacturing, so as to not induce a voltage to the element 1 even if disturbance noise enters from the substrate side or ESD is developed, and also provide a manufacturing method thereof, a head suspension assembly and a magnetic storage device.

### BRIEF DESCRIPTION OF THE DRAWINGS

FIG. 1(a) is a schematic diagram of a magnetic head viewed in the direction perpendicular to a film surface thereof and FIG. 1(b) is a cross-sectional view of the same magnetic head along the line A-A′.

FIG. 2(a) is a schematic diagram of the magnetic head viewed in the direction perpendicular to the film surface thereof and FIG. 2(b) is a cross-sectional view of the same magnetic head along the line B-B′.

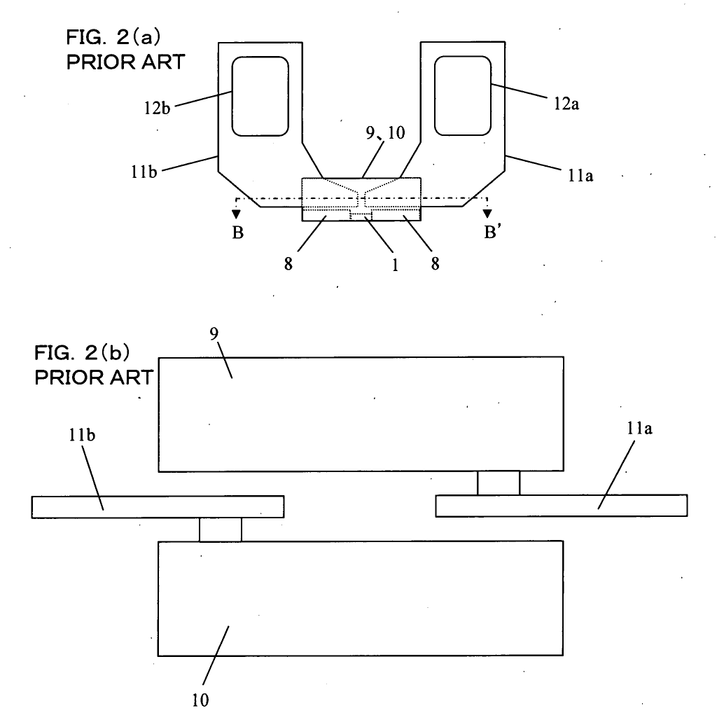

FIG. 3(a) is a schematic circuit diagram of the magnetic head of the related art using a tunnel magnetoresistive element including bleed resistance electrical terminals and FIG. 3(b) is a plan view of the same magnetic head viewed in the direction perpendicular to the film surface thereof.

FIG. 4(a) is a schematic circuit diagram of the magnetic head in a first embodiment and FIG. 4(b) is a plan view of the same magnetic head viewed in the direction perpendicular to the film surface thereof.

FIG. 5(a) is a schematic circuit diagram of the magnetic head in a second embodiment and FIG. 5(b) is a plan view of the magnetic head in the second embodiment viewed in the direction perpendicular to the film surface thereof.

FIG. 6 is a plan view of the magnetic head in a third embodiment viewed in the direction perpendicular to the film surface thereof.

FIG. 7 is a plan view of a magnetic head viewed in the direction perpendicular to the film surface thereof before cut-away of the structure to be grounded in a fourth embodiment.

FIG. 8 is a plan view of the magnetic head of FIG. 7, viewed in the direction perpendicular to the film surface thereof after cut-away of some of the structure to be grounded in the fourth embodiment.

FIG. 9 is a plan view of a magnetic storage device using the magnetic head of the present invention.

FIG. 10(a) and FIG. 10(b) is an enlarged perspective view of a suspension using the magnetic head of the present invention.

### SUMMARY OF THE INVENTION

In keeping with one aspect of this invention, a means for adjusting impedance between a grounded substrate and each bleed resistance electric terminal of a magnetoresistive the element, and the upper and lower magnetic shields and electrodes of the element is provided.

A magnetic head on a substrate to be grounded through a housing, external device or the like includes a magnetoresistive element, a pair of electrodes for feeding a current in the direction perpendicular to a film surface of the magnetoresistive element, a pair of conductive wires for transferring electrical signals read from the magnetoresistive element via a pair of electrodes to an external circuit or device, and a pair of second conductive wires for discharging static electricity by electrically connecting a pair of the first conductive wires to the substrate. An electrically shielded layer is provided between the first conductive wires and the substrate and/or between the pair of second conductive wires and the substrate, and the shielded layer is grounded as initially manufactured.

The magnetic head of the present invention is capable of having capacitances C+, C− between the first conductive wires and the substrate or between the second conductive wires and the substrate adjusted during or after fabrication. Balance of impedance between the grounded substrate and each bleed resistance electric terminal, and the upper and lower magnetic shields electrodes at the positive (Z+)/negative (Z−) sides can be more closely achieved by changing the extent to which the electrically shielded layer of the structure is grounded.

Moreover, the magnetic head of the present invention can be manufactured by fabricating, on a substrate to be grounded, a magnetoresistive element, a pair of electrodes for feeding a current in the direction perpendicular to a film surface of the magnetoresistive element, a pair of first conductive wires for transferring electrical signals read from the magnetoresistive element via a pair of the electrodes, and a pair of second conductive wires for discharging static electricity by electrically connecting a pair of the first conductive wires to the substrate through high resistance. One or more electrically shielded layers are formed within the film surface of the magnetoresistive film between the pair of first conductive wires and the substrate and/or between the pair of the second conductive wires and the substrate. The shielded layers can be grounded, and the capacitance C+, C− thereof can be adjusted by cutting the ground connections as needed to balance the input impedance of the magnetoresistive element.

Since capacitances C+ and C− are varied in accordance with the total area of the electrically shielded layers, the magnetic head of the present invention explained above can be manufactured easily by initially forming one or more of the electrically shielded layers, grounding them separately, and electrically cutting the ground connections as needed.

Suitable cutting methods include ion milling and focused ion beam (FIB). Ion milling is the technology which is generally employed in the process of forming the read head element or a write head element.

It is also possible to provide a head suspension assembly by electrically joining a substrate of such a magnetic head and a suspension. In this manner, it is possible to provide a magnetic storage device which is highly stable with respect to disturbance noise by grounding the substrate of the magnetic head through the suspension, actuator arm and housing.

With the present invention, impedance between the grounded substrate and each bleed resistance electric terminal and impedance between the grounded substrate and the upper and lower magnetic shields of each electrode can be adjusted and better balanced. The error rate of the device resulting from disturbance noise can be reduced, and magnetic head development times can also be reduced.

### DETAILED DESCRIPTION OF THE DRAWINGS

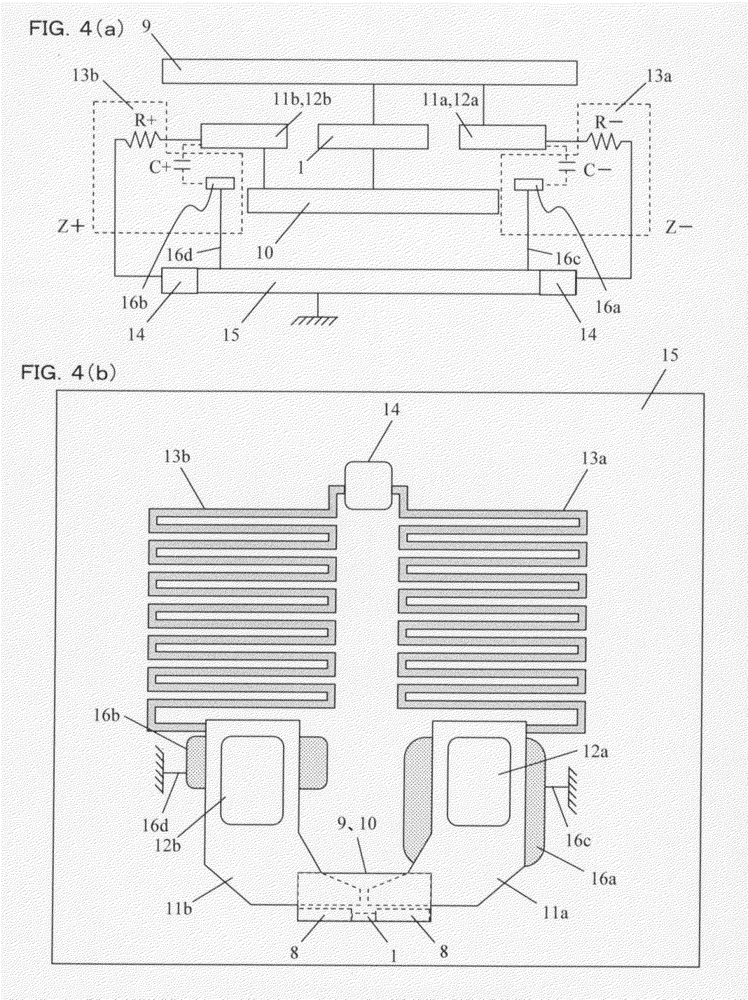

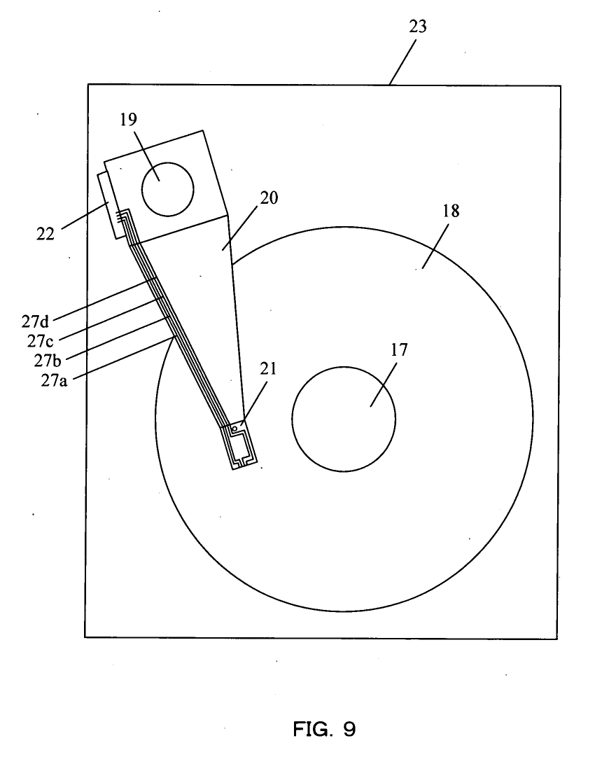

As seen in FIGS. 4(a) and 4(b), a magnetic head includes a substrate 15 to be grounded, a magnetoresistive element 1, a pair of electrodes 9, 10 for feeding a current in the direction perpendicular to a film surface of the magnetoresistive element 1, a pair of first conductive wires (lead-out conductive wires 11a, 11b, and bonding pads 12a, 12b) for transferring an electrical signal read from the magnetoresistive element 1 via a pair of the electrodes 9, 10.to a detecting circuit device 22 (FIG. 9), and a pair of second conductive wires (bleed resistance electrical terminals 13a, 13b) for discharging static electricity by electrically connecting a pair of the first conductive wires (lead-out conductive wires 11a, 11b, bonding pads 12a, 12b) to the substrate 15 through high resistance. Electrically grounded shielded layers 16a, 16b are provided between the pair of the first conductive wires (lead-out conductive wires 11a, 11b, bonding pads 12a, 12b) and the substrate 15. The layers 16a, 16b are connected to ground by leads 16c, 16d.

The magnetoresistive element of the present invention can be a tunnel type magnetoresistive element and a perpendicularly feeding type magnetoresistive element such as CPP-GMR. In this embodiment, the tunnel type magnetoresistive element is used. The pair of electrodes 9, 10 also work as the upper and lower magnetic shields and are formed of NiFe, FeN or the like in the thickness of about 0.5 to 2 μm. In addition, the bleed resistance electrical terminals 13a, 13b as the second conductive wires are formed in a winding pattern and have a resistance of about 1 MΩ or more. Moreover, the conductive wires (lead-out wires 11a, 11b, bonding pads 12a, 12b and bleed resistance electrical terminals 13a, 13b) may be formed with a conductive material such as Cu.

Since the electrically grounded shielded layers 16a, 16b function as shields, capacitances C+, C− between the first conductive wires and the substrate 15 are reduced, and impedance balance between Z+ and Z− can also be improved. The assumed reasons are that (1) fluctuation in capacitance itself is reduced due to a reduction of capacitance, and (2) impedance balance is improved by adjusting the capacitance. In this embodiment, the electrically shielded layers 16a, 16b are provided both in the positive and negative sides, but it is also enough when the electrically shielded layer is provided only in one side thereof for the reason (2) explained above. Also, of course, the ground connections 16c, 16d for layers 16a, 16b can be severed as desired, to further adjust the impedance balance.

The substrate 15 is formed, for example, of Al₂O₃—TiC and it is cut away and processed into a slider 24 after formation of magnetoresistive elements and conductive wires or the like. Moreover, the slider 24 is grounded, together with the suspension 21, actuator arm 20 and magnetic disk 18, via a housing 23 (FIG. 9), which supports and stores these components. Accordingly, grounding of the electrically shielded layers is established with electrical connection, for example, to the slider 24 (substrate 15).

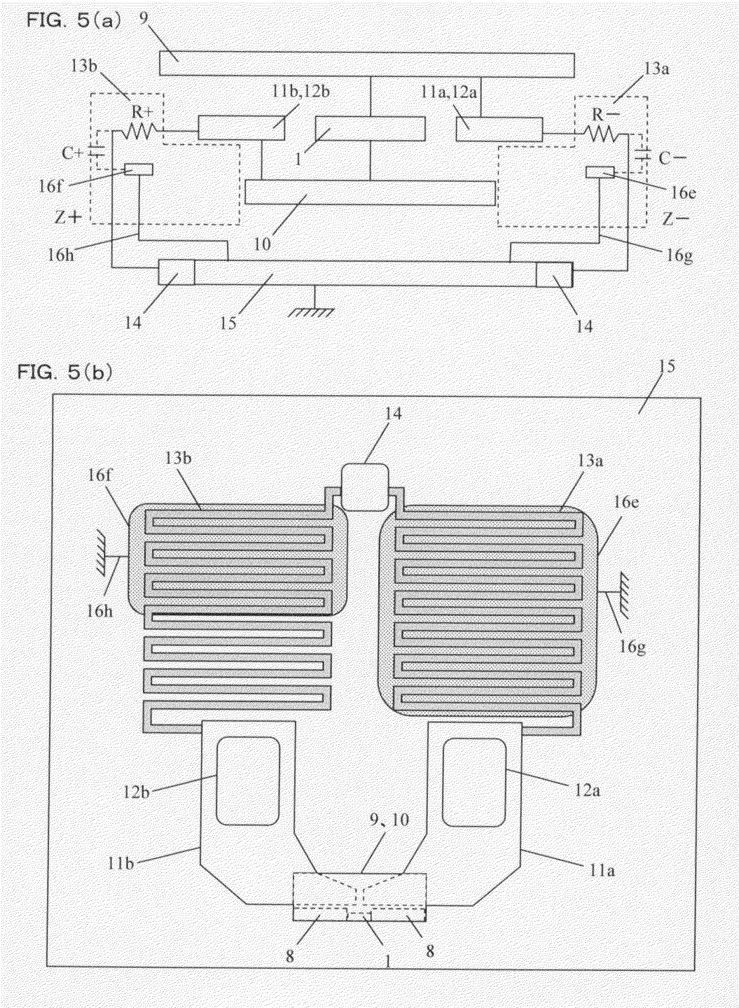

FIGS. 5a and 5b are schematic and plan views of another magnetic head of the present invention, viewed in the direction perpendicular to a film surface thereof. This second embodiment is different from the first embodiment in that electrically shielded layers 16e, 16f are located between the pair of second conductive wires (bleed resistance electrical terminals 13a, 13b) and the substrate 15, but the other portions are similar to the first embodiment, because capacitances C+, C− between the second conductive wires and the substrate are reduced, resulting in a similar effect. Leads 16g, 16h connect the layers 16e, 16f to ground, and either or both leads 16g, 16h can be cut to balance impedance as desired.

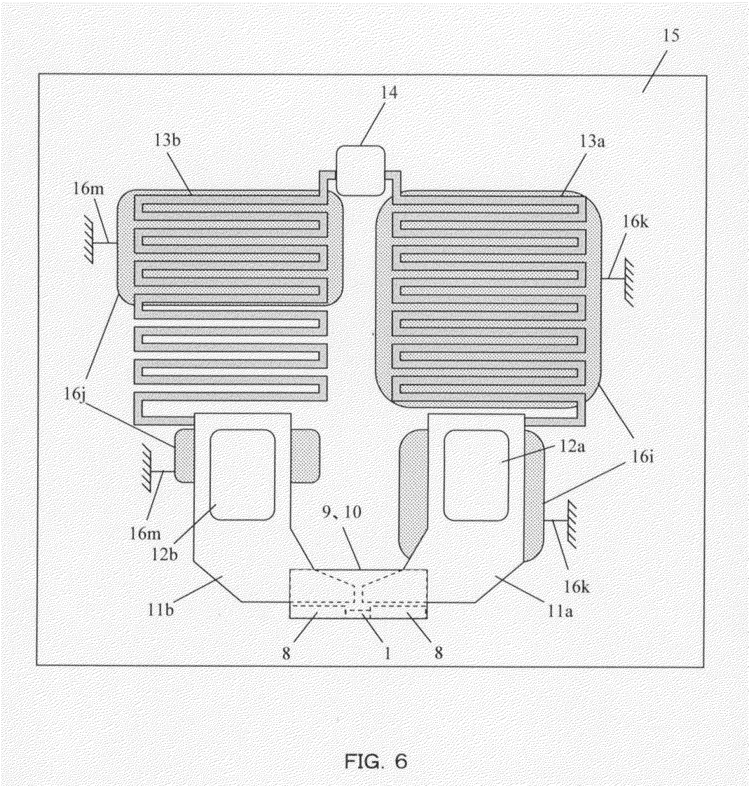

FIG. 6 is a plan view of a third embodiment of the magnetic head of the present invention viewed in the direction perpendicular to a film surface thereof. In this embodiment, electrically shielded layers 16i, 16j are placed between a pair of the first conductive wires (lead-out wires 11a, 11b, bonding pads 12a, 12b) and the substrate 15, and between a pair of the second conductive wires (bleed resistance electrical terminals 13a, 13b) and the substrate 15. The other portions are similar to the first embodiment, because capacitances C+, C− between the first conductive wires and the substrate and between the second conductive wires and the substrate are reduced, resulting in a similar effect. Leads 16k, 16m connect the layers 161, 16j to ground, and can individually cut as desired to balance impedances.

As the first to the third embodiments disclose, similar effects can be attained in the case where a grounded electrically shielded layer is provided between any or all of the first and second conductive wires, and the substrate. It is now apparent that the ground connections of the layers can be individually disconnected from ground, to obtain desired capacitances and impedances.

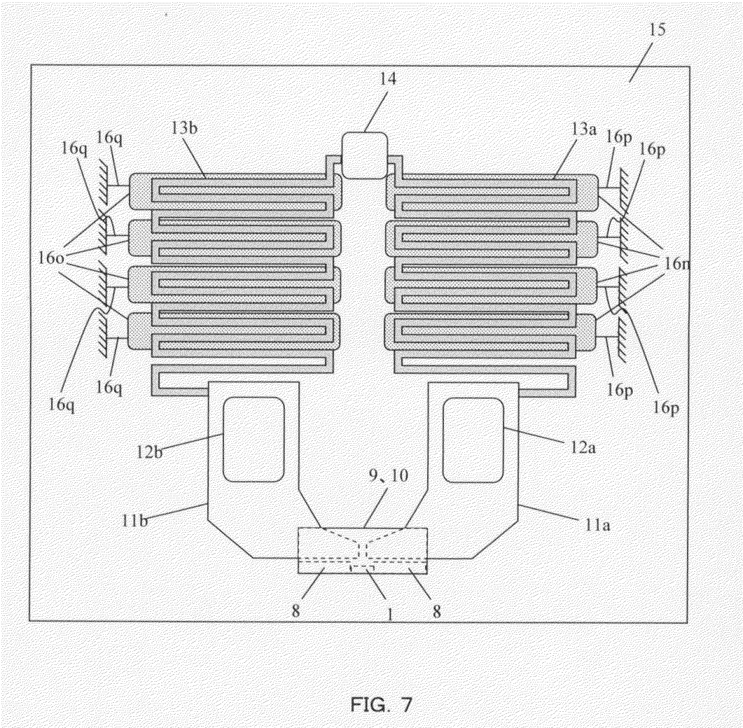

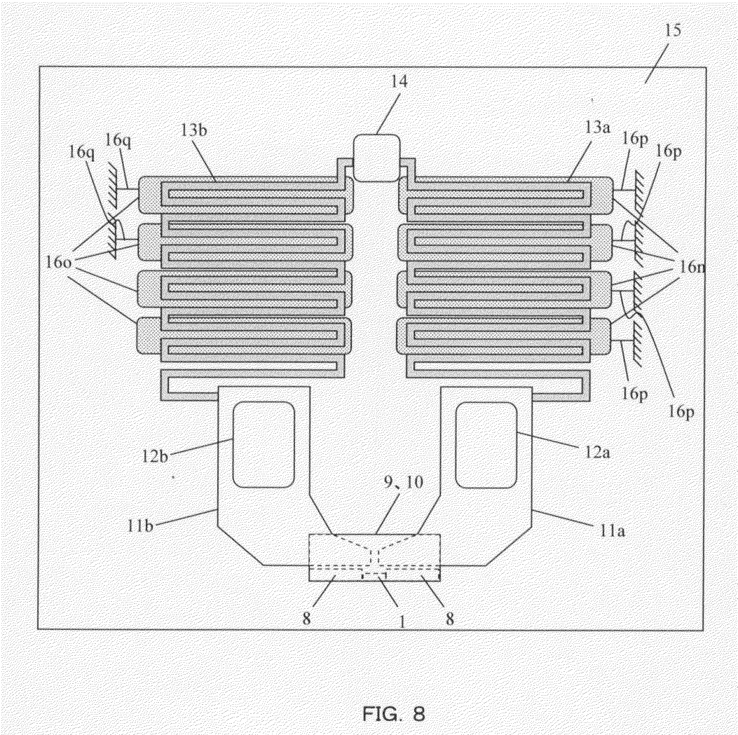

FIG. 7 and FIG. 8 show a fourth embodiment of the magnetic head of the present invention. FIG. 7 is a plan view of the magnetic head viewed in the direction perpendicular to a film surface before severing selected ground connections of the shielded layers. As shown in FIG. 7, the magnetic head has a substrate 15 to be grounded, a magnetoresistive element 1, a pair of electrodes 9, 10 for feeding a current in the direction perpendicular to a film surface of the magnetoresistive element, a pair of first conductive wires (lead-out wires 11a, 11b, bonding pads 12a, 12b) for transferring electrical signals read from the magnetoresistive element 1 via the electrodes 9, 10 to a detecting circuit device 22 (FIG. 9), and a pair of second conductive wires (bleed resistance electrical terminals 13a, 13b) for discharging static electricity by electrically connecting a pair of the first conductive wires (lead-out wires 11a, 11b, bonding pads 12a, 12b) and the substrate through the connection strap 14. In this magnetic head, a plurality of electrically shielded layers 16n, 16o are formed within the film surface of the magnetoresistive element between the second conductive wires 13a, 13b and the substrate 15.

These electrically shielded layers are electrically isolated from each other and each respective layer is individually grounded by leads 16p, 16q. Therefore, since each electrically shielded layer functions as a shielding plate, the capacitances C+, C− between the second conductive wires and the substrate are lower than that in the related art.

If the impedance balance is rather bad because a capacitance C+ of the electrode in the positive side is too small, with too much capacitance in the positive side, any of the grounded electrically shielded layers between the second conductive wires and the substrate in the positive side can be cut away electrically. FIG. 8 is a plan view of the magnetic head viewed in the direction perpendicular to a film surface after severing selected ground connections in the fourth embodiment.

Since the ungrounded electrically shielded layers do not function as shielding plates, capacitance C+ increases. Impedance balance is adjusted in accordance with the increase or decrease of capacitance. Moreover, since the capacitance is fine adjusted, it is also possible that the amount of adjustment of capacitance can be varied by providing different areas within the film surface of a plurality of electrically shielded layers. For electrical severance of the selected ground connections, ion milling, for example, can be used.

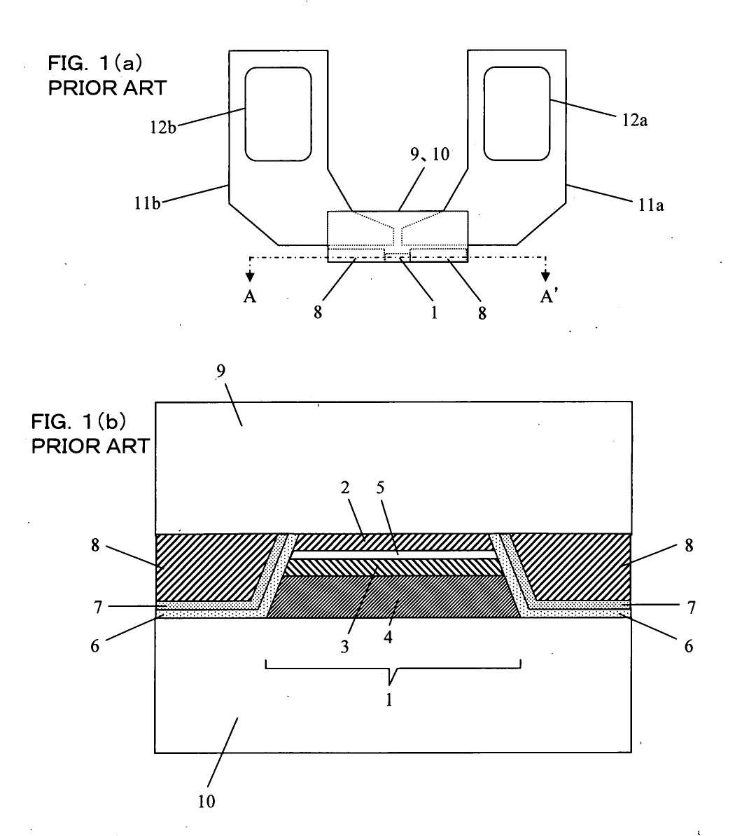

The manufacturing method of the magnetic head explained in the fourth embodiment can also provide similar effects of a plurality of electrically shielded layers are located between the conductive wires and the substrate, including both the first and second conductive wires. Moreover, the magnetic head of the present invention and manufacturing method thereof can be applied not only to the tunnel type magnetoresistive (TMR) read head element shown in FIG. 1(a), but also to the perpendicularly feeding type magnetoresistive read head element such as GMR head element having the CPP structure and to the manufacturing method of such magnetic heads.

FIG. 9 is a plan view of a magnetic storage device using the magnetic head of the present invention. The magnetic disk 18 stores magnetic information and is rotated at high speed by a spindle motor 17. The actuator arm 20 is provided with the suspension 21 formed of flexible stainless steel. Moreover, the actuator arm 20 is fixed to freely rotate in the housing 23 about a pivot 19, allowing the actuator arm 20 to move almost in the radius direction of the magnetic disk 18. Accordingly, the slider explained later moves over the magnetic disk 18 for recording and reading information on predetermined tracks of the disk 18. At a side surface of the actuator arm 20, the detecting circuit device 22 is secured for detecting such recorded signals. The detecting circuit device detects changes of resistance in the magnetoresistive element 1 and recovers information from the medium 18 through measurement of the voltage across the magnetoresistive element 1 by applying sense current to the magnetoresistive element 1.

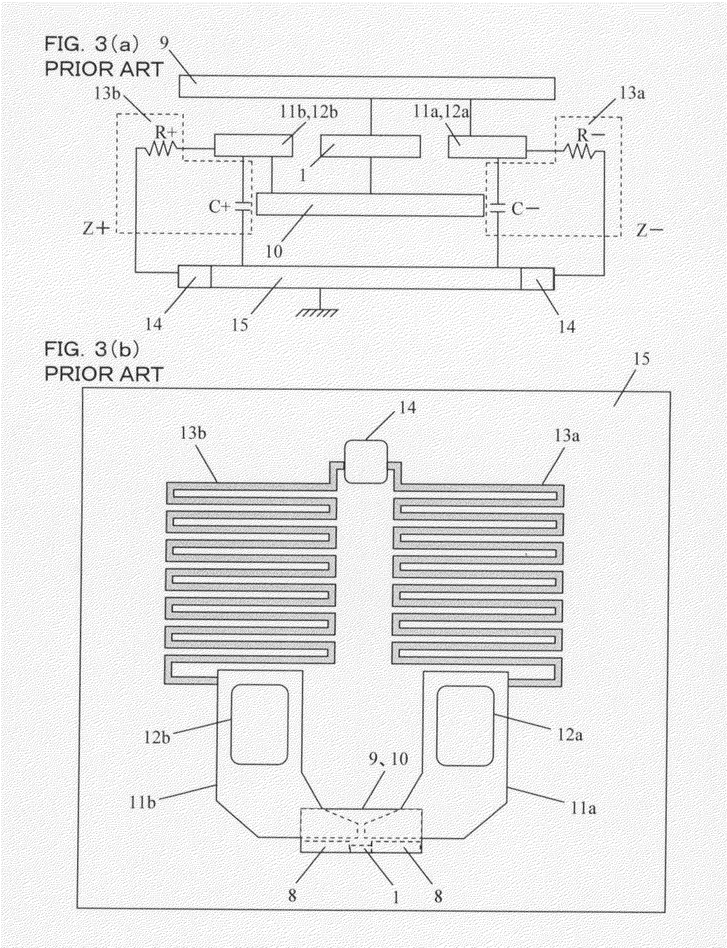

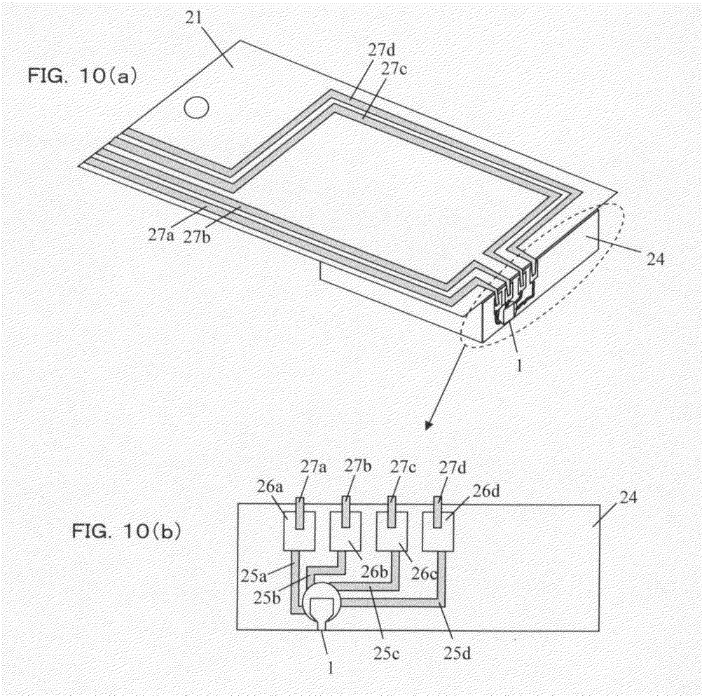

FIG. 10(a) is an enlarged perspective view of the suspension 21 in this embodiment. The slider 24 is mounted to the suspension 21 under the lower side thereof to constitute a head suspension assembly. Since the magnetic disk 18 rotates at high velocity, air is pulled into a gap between the slider 24 and the magnetic disk 18 and therefore the slider 24 floats due to this air pressure. The electrodes 9, 10 of the magnetoresistive element 1, electrodes of a write element, and bonding pads 26a to 26d are electrically connected by conductive traces 25a to 25d. The bonding pads 26a to 26d are further electrically connected to the detecting circuit device via insulated conductive traces 27a to 27d on the suspension 21 and actuator arm 20. In addition, the substrate 15 shown in FIG. 3 to FIG. 8 is grounded through electrical connection to the suspension 21 and electrical connection to the housing via the suspension 21 and actuator arm 20.

While the principles of the invention have been described above in connection with specific apparatus and applications, it is to be understood that this description is made only by way of example and not as a limitation on the scope of the invention.

What is claimed is:

1. A magnetic head on a grounded substrate, the magnetic head comprising:
a magnetoresistive element having a planar film surface,
a pair of electrodes for feeding a current in the direction perpendicular to said film surface,
a pair of first conductive wires for transferring an electrical signal read from said magnetoresistive element via said pair of said electrodes to an external side, said first conductive wires being electrically isolated from the substrate such that said first conductive wires and the substrate have appreciable capacitive impedance,
a pair of second conductive wires for discharging static electricity by electrically connecting said pair of said first conductive wires and said substrate, said second conductive wires having sufficient electrical resistance so that head performance is not substantially affected by said second conductive wires, said second conductive wires and the substrate having appreciable capacitive impedance, and
an electrically shielded layer of groundable structure between said pair of said first conductive wires and said substrate or between said pair of said second conductive wires and said substrate,
said shielded layer balancing the impedances between respective said electrodes and the substrate by being grounded or not grounded to the substrate.

2. A magnetic head comprising, on a grounded substrate,
a magnetoresistive element,
a pair of electrodes for feeding a current in the direction perpendicular to a film surface of said magnetoresistive element,
a pair of first conductive wires for transferring an electrical signal read from said magnetoresistive element via a pair of said electrodes to an external side,
a pair of second conductive wires for discharging static electricity by electrically connecting a pair of said first conductive wires and said substrate, and
a plurality of electrically shielded layers which are electrically separated within a surface of said magnetoresistive film between a pair of said first conductive wires and said substrate or between a pair of said second conductive wires and said substrate, wherein at least a shielded layer among a plurality of said electrically shielded layers is grounded.

3. A method of manufacturing magnetic heads comprising the steps of forming a substrate,
a magnetoresistive element,
a pair of electrodes for feeding a current in the direction perpendicular to a film surface of said magnetoresistive element,
a pair of first conductive wires for transferring an electrical signal read from said magnetoresistive element via a pair of said electrodes to an external device,
a pair of second conductive wires for discharging static electricity by electrically connecting said pair of said first conductive wires to said substrate through bleed resistance, and
a plurality of electrically shielded layers of grounded structure which are electrically separated within a film surface of said magnetoresistive element between said pair of said first conductive wires and said substrate or between said pair of said second conductive wires and said substrate, and
severing ground connections of selected shielded layers.

4. The manufacturing method of magnetic head according to claim 3, characterized in that said grounded connections are severed with ion milling or with focused ion beam.

5. A head suspension assembly characterized in a structure constituted with
magnetic head formed by allocating, on a grounded substrate, a magnetoresistive element, a pair of electrodes for feeding a current in the direction perpendicular to a film surface of said magnetoresistive element, a pair of first conductive wires for transferring an electrical signal read from said magnetoresistive element via a pair of said electrodes to an external side, a pair of second conductive wires for discharging static electricity by electrically connecting a pair of said first conductive wires and said substrate, and an electrically shielded layer of grounded structure which is provided to at least a part between a pair of said first conductive wires and said substrate or between a pair of said second conductive wires and said substrate, and
a flexible conductive suspension electrically joined with said substrate.

6. A magnetic storage device characterized in comprising
a magnetic disk,
a magnetic head formed by allocating, on a grounded substrate, a magnetoresistive element, a pair of electrodes for feeding a current in the direction perpendicular to a film surface of said magnetoresistive element, a pair of first conductive wires for transferring an electrical signal read from said magnetoresistive element via a pair of said electrodes to an external side, a pair of second conductive wires for discharging static electricity by electrically connecting a pair of said first conductive wires and said substrate, and an electrically shielded layer of grounded structure which is provided to at least a part between a pair of said first conductive wires and said substrate or between a pair of said second conductive wires and said substrate,
a flexible conductive suspension electrically joined with said substrate,
a rotatable actuator arm electrically connected with a housing formed of a conductive material for fixing an end part of said suspension, and
a detecting circuit electrically connected to a pair of said first conductive wires for detecting an electrical signal read by said magnetoresistive element from said magnetic disk.
